(19) United States
(12) Patent Application Publication
(10) Pub. No.: US 2022/0010181 A1
(43) Pub. Date: Jan. 13, 2022

(54) DECORATIVE FILM FOR VEHICLE EXTERIOR

(71) Applicant: 3M INNOVATIVE PROPERTIES COMPANY, St. Paul, MN (US)

(72) Inventors: Katsuya Ono, Tokyo (JP); Shinji Ikeda, Tokyo (JP)

(21) Appl. No.: 17/295,675

(22) PCT Filed: Nov. 27, 2019
(86) PCT No.: PCT/IB2019/060237

§ 371 Date: May 20, 2021

(30) Foreign Application Priority Data
Nov. 29, 2018 (JP) 2018-223648

(51) Int. Cl. C09J 133/10; C09J 133/08; C08J 7/04

(52) U.S. Cl. CPC C09J 133/10; C09J 133/08; C08J 7/042; C09J 2203/354; C09J 2467/006; C09J 2475/006; C09J 2203/306

(57) ABSTRACT

A decorative film for a vehicle exterior of an embodiment of the present disclosure includes a resin layer and an adhesive layer, wherein tearing strength of the resin layer is approximately 8.0 N or more at 20° C., the adhesive layer includes a reaction product of a crosslinking agent and a (meth)acrylate polymer obtained from a material containing a monoethylenically unsaturated monomer and an unsaturated monomer containing a carboxyl group, a glass transition temperature of the (meth)acrylate polymer is approximately −58° C. or more and approximately −40° C. or less, and the unsaturated monomer containing a carboxyl group is incorporated by an amount of approximately 3 mass % or more and approximately 10 mass % or less of a total amount of 100 mass % of the monoethylenically unsaturated monomer and the unsaturated monomer containing a carboxyl group is described. The decorative film may be capable of reducing a defect such as lifting p even in exposure to wind, rain, wind pressure and the like.

### TECHNICAL FIELD

The present disclosure relates to a decorative film for a vehicle exterior.

### BACKGROUND ART

In recent years, a decorative film has been used in place of painting as decorative means for various types of vehicles from a perspective of reducing the use of solvent and shortening the construction period.

Patent Document 1 (JP 2001-334934 A) describes a railway vehicle in which a total peripheral surface of an outer plate of the vehicle excluding non-colored locations such as a door knob and a window frame includes a predetermined color or pattern, and is coated in a patterned shape with a film having a flame retardant function.

Patent Document 2 (JP 6187632 B) describes an adhesive film for a vehicle sticker to be affixed in a vehicle, and the adhesive film includes a concealing base material including at least a white resin film layer and a concealing layer, and an adhesive agent layer, and the white resin film layer includes from 5 to 30 mass % of titanium dioxide and is made of an unstretched resin film having a thickness of from 25 to 100 μm.

Patent Document 3 (JP 2007-297569 A) describes a decorative layer-forming film used in an automobile and the like, and the film includes a top coat layer made of a specific polyurethane resin, and a carrier film provided on a surface side of the top coat layer.

### SUMMARY OF INVENTION

### Technical Problem

The exterior of a vehicle is exposed to rain, snow, wind and the like, and is subjected to significant wind pressure during travel. Even when a decorative film is applied as a label or the like to a portion of an exterior of a vehicle, a peripheral end portion of the decorative film is constantly affected by wind, rain, wind pressure, and the like. Moreover, even when the decorative film is applied to an entire outer surface of the vehicle, a joint portion of the decorative film is generally present, and thus the joint portion of the decorative film is susceptible to wind, rain, wind pressure and the like. As a result, a defect such as lifting up and tearing of the decorative film may occur.

The present disclosure provides a decorative film for a vehicle exterior capable of reducing or preventing a problem such as lifting up even in exposure to wind, rain, wind pressure, and the like.

### Solution to Problem

According to an embodiment of the present disclosure, a decorative film for a vehicle exterior is provided, the decorative film including a resin layer and an adhesive layer, wherein tearing strength of the resin layer is approximately 8.0 N or more at 20° C., the adhesive layer includes a reaction product of a crosslinking agent and a (meth)acrylate polymer obtained from a material including a monoethylenically unsaturated monomer and an unsaturated monomer containing a carboxyl group, a glass transition temperature of the (meth)acrylate polymer is approximately −58° C. or more and approximately −40° C. or less, and the unsaturated monomer containing a carboxyl group is incorporated by an amount of approximately 3 mass % or more and approximately 10 mass % or less of a total amount of 100 mass % of the monoethylenically unsaturated monomer and the unsaturated monomer containing a carboxyl group.

### Advantageous Effects of Invention

According to the present disclosure, a decorative film for a vehicle exterior capable of reducing or preventing a problem such as lifting up even in exposure to wind, rain, wind pressure, and the like can be provided.

The above description will not be construed to mean that all embodiments of the present invention and all advantages of the present invention are disclosed.

### BRIEF DESCRIPTION OF DRAWINGS

FIG. 1 is a cross-sectional view of a decorative film for a vehicle exterior according to an embodiment of the present disclosure.

FIG. 2 is a cross-sectional view of a decorative film for a vehicle exterior according to another embodiment of the present disclosure.

### DESCRIPTION OF EMBODIMENTS

The decorative film for a vehicle exterior of a first embodiment of the present disclosure includes a resin layer and an adhesive layer, and tearing strength of the resin layer is approximately 8.0 N or more at 20° C. The adhesive layer includes a reaction product of a crosslinking agent and a (meth)acrylate polymer obtained from a material including a monoethylenically unsaturated monomer and an unsaturated monomer containing a carboxyl group, and a glass transition temperature of the (meth)acrylate polymer is approximately −58° C. or more and approximately −40° C. or less. The unsaturated monomer containing a carboxyl group is incorporated by an amount of approximately 3 mass % or more and approximately 10 mass % or less of a total amount of 100 mass % of the monoethylenically unsaturated monomer and the unsaturated monomer containing a carboxyl group. Since the decorative film includes the specific resin layer and the specific adhesive layer, a problem such as lifting up can be reduced even in exposure to wind, rain, wind pressure, and the like. This is believed that rigidity based on the specific resin layer and adhesive strength with an adherend based on the specific adhesive layer contribute.

The tearing strength of the resin layer of the decorative film according to the first embodiment can be set to approximately 15.0 N or more at −5° C. The decorative film provided with the resin layer having such tearing strength can exhibit sufficient wind, rain, and wind pressure resistance even in the case of a vehicle traveling in a low temperature environment, for example.

The thickness of the resin layer of the decorative film of the first embodiment may be approximately 100 μm or more. When the thickness of the resin layer is within this range, rigidity increases, and a problem such as lifting up can further be ameliorated.

The resin layer of the decorative film of the first embodiment can include at least one selected from a polyurethane resin, a polyolefin resin, and a polyester resin. The resin layer formed from such a material can further ameliorate a problem such as lifting up.

The decorative film of the first embodiment can further include at least one selected from a protective layer and a decorative layer. Weather resistance, solvent resistance, and a decorative property of the decorative film can further be improved by including such a layer.

The decorative film of the first embodiment can be used for an exterior of a railway vehicle. The decorative film of the present disclosure can reduce a problem such as lifting up even in exposure to wind, rain, wind pressure, and the like, and thus can even be used for a railway vehicle that travels at high speed.

Although representative embodiments of the present invention will now be described in greater detail for the purpose of illustration with reference to the drawings, the present invention is not limited to these embodiments. As for the reference signs in the drawings, elements denoted by similar reference signs in different drawings indicate similar or corresponding elements.

In the present disclosure, a “film” also includes an article referred to as a “sheet.”

In the present disclosure, a “low temperature environment” can be intended to mean, for example, a winter environment or a high altitude environment in which an airplane travels. Specifically, the “low temperature environment” can be intended to mean, for example, an environment with a temperature of approximately 0° C. or less, approximately −5° C. or less, or approximately −10° C. or less. A lower limit value of the temperature in the low temperature environment is not particularly limited, but can be defined as, for example, approximately −50° C. or more, approximately −40° C. or more, or approximately −30° C. or more.

In the present disclosure, a “high temperature environment” can be intended to mean, for example, a summer environment. Specifically, the “high temperature environment” can be intended to mean, for example, an environment with a temperature of approximately 35° C. or more, approximately 37° C. or more, or approximately 40° C. or more. An upper limit value of the temperature in the high temperature environment is not particularly limited, but can be defined as, for example, approximately 60° C. or less, approximately 55° C. or less, or approximately 50° C. or less.

In the present disclosure, “high-speed” can be defined as approximately 100 km/hr or more, approximately 150 km/hr or more, approximately 200 km/hr or more, approximately 250 km/hr or more, or approximately 300 km/hr or more. An upper limit value is not particularly limited, but can be defined as, for example, approximately 1200 km/hr or less, approximately 1000 km/hr or less, approximately 800 km/hr or less, or approximately 700 km/hr or less. This speed can be intended to mean maximum speed.

In the present disclosure, “transparent” means that an average transmittance in a visible light region (wavelength from approximately 400 nm to approximately 700 nm) is approximately 80% or more, and desirably approximately 85% or more, or approximately 90% or more. An upper limit value of the average transmittance is not particularly limited, but for example, can be defined as approximately less than 100%, approximately 99% or less, or approximately 98% or less.

In the present disclosure, “translucent” means that an average transmittance in a visible light region (wavelength from approximately 400 nm to approximately 700 nm) is less than approximately 80%, and desirably approximately 75% or less, and is intended to mean that an underlying layer is not completely hidden.

In the present disclosure, “(meth)acrylic” means acrylic or methacrylic, and “(meth)acrylate” means acrylate or methacrylate.

Hereinafter, a decorative film for a vehicle exterior (may be referred to simply as a “decorative film”) will further be described.

The decorative film for a vehicle exterior of the present disclosure can be used in an environment with exposure to wind, rain, wind pressure, and the like, or in a low temperature environment.

The decorative film for a vehicle exterior of the present disclosure can be applied to various sites constituting an exterior of a vehicle. For example, the decorative film can be applied to at least any surface on the outside of a vehicle selected from a front surface, a back surface, a side surface, a top surface, and a bottom surface. In particular, the decorative film is preferably applied to a site that is observable by a viewer while a vehicle is traveling. Specifically, in a railway vehicle or an automobile, the decorative film can be applied to all surfaces other than a bottom surface, and in an airplane, the decorative film can be applied to an entire surface. The decorative film may be applied to all regions of each surface or may be applied to a portion of each surface as a display article such as a logo.

The decorative film of the present disclosure can exhibit excellent adhesiveness. Adhesiveness can be evaluated, for example, by an adhesive strength test described in the examples described below.

Adhesive strength can be defined as approximately 10 N or more, approximately 11 N or more, or approximately 12 N or more under conditions of 20° C. and 65% relative humidity (RH) for 24 hours. An upper limit value of the adhesive strength is not particularly limited, but can be defined as, for example, approximately 30 N or less, approximately 28 N or less, or approximately 25 N or less.

Adhesive strength under conditions of 24 hours at 5° C. can be defined as approximately 15 N or more, approximately 18 N or more, or approximately 20 N or more. An upper limit value is not particularly limited, but can be defined as, for example, approximately 40 N or less, approximately 38 N or less, or approximately 35 N or less.

The decorative film of the present disclosure can exhibit high wind, rain, and wind pressure resistance. Wind, rain and wind pressure resistance can be evaluated, for example, by a high pressure washing test that imitates wind, rain, and wind pressure and that is described in the examples described below. The decorative film of the present disclosure can reduce or suppress occurrence of deformation, peeling and the like of the film in such a test.

The decorative film of the present disclosure can exhibit excellent impact resistance (chipping resistance). Impact resistance can be evaluated, for example, by an impact resistance test in an atmosphere of approximately −20° C. described in the examples described below. Such performance is characteristic performance of a decorative film that is required, for example, in the case of replacing a film that has been damaged by dust or ice in a tunnel, or ice attached to the vehicle itself during traveling, or in the case of changing to a new design after long term use, and a decorative film having excellent impact resistance can simplify a replacement work step.

The thickness of the decorative film (excluding the thickness of a release liner when the release liner is present) is not limited to the following thicknesses, but can be set, for example, to approximately 120 μm or more, approximately 150 μm or more, approximately 200 μm or more, or approximately 250 μm or more, and can be set to approximately 1 mm or less or approximately 500 μm or less. Setting the thickness of the decorative film to approximately 120 μm or more imparts necessary performance such as toughness to the film, and when the thickness of the decorative film is set to approximately 1 mm or less, flexibility is imparted to the film, the decorative film can sufficiently track even an adherend (member on the outer side of a vehicle) having a complex shape such as a curved surface shape, and excellent appearance can be provided.

From a perspective of wind, rain, and wind pressure resistance, the resin layer of the present disclosure preferably has tearing strength of approximately 8.0 N or more at 20° C. Further, when the decorative film has tearing strength of approximately 15.0 N or more at −5° C., the decorative film has sufficient tearing strength not only at ambient temperature but also at a low temperature, and thus the decorative film for an exterior that exhibits sufficient wind, rain and wind pressure resistance can be provided, particularly even in the case of a vehicle that travels in a low temperature environment.

The tearing strength of the resin layer of the present disclosure in an atmosphere of 20° C. can be defined as approximately 8.0 N or more, approximately 9.0 N or more, or approximately 10.0 N or more. An upper limit value is not particularly limited, but can be defined as, for example, approximately 50.0 N or less, approximately 40.0 N or less, or approximately 30.0 N or less.

The tearing strength of the resin layer of the present disclosure in an atmosphere of −5° C. can be defined as approximately 15.0 N or more, approximately 18.0 N or more, or approximately 20.0 N or more. An upper limit value is not particularly limited, but can be defined as, for example, approximately 70.0 N or less, approximately 60.0 N or less, or approximately 50.0 N or less.

The tearing strength of the resin layer of the present disclosure in an atmosphere of 5° C. can also be defined. Such tearing strength can be defined as approximately 12.0 N or more, approximately 13.0 N or more, or approximately 15.0 N or more. An upper limit value is not particularly limited, but can be defined as, for example, approximately 60.0 N or less, approximately 50.0 N or less, or approximately 40.0 N or less.

The thickness of the resin layer of the present disclosure is not particularly limited, but can be defined as, for example, approximately 100 μm or more, approximately 110 μm or more, approximately 120 μm or more, approximately 150 μm or more, approximately 180 μm or more, or approximately 200 μm or more. An upper limit value is not particularly limited, but from a perspective of a manufacturing cost, the upper limit value can be defined as, for example, approximately 1 mm or less, approximately 700 μm or less, approximately 500 μm or less, or approximately 300 μm or less.

When the thickness of the resin layer increases, the cross-sectional thickness of the decorative film also generally increases, and thus it is expected that the decorative film is susceptible to resistance such as wind pressure and is prone to have a problem such as lifting up. Therefore, to avoid wind pressure resistance, it is generally assumed that the thickness of the resin layer will be reduced. However, surprisingly, when the thickness of the resin layer is reduced, contrarily a problem such as lifting up easily occurs. Although the reason why a problem such as lifting up is less likely to occur when the thickness of the resin layer is increased is unclear, it is considered that this is because the rigidity of the resin layer also increases as the thickness of the resin layer increases, and thus the decorative film becomes more resistant to wind pressure. This also correlates with the result indicating that increasing a numeric value of the tearing strength described above is preferable.

A material of the resin layer of the present disclosure is not particularly limited, but at least one selected from a polyurethane resin, a polyolefin resin, and a polyester resin can be employed. Among these, a polyurethane resin is preferable. In addition to wind, rain and wind pressure resistance, a polyurethane resin layer can also improve impact resistance. Vinyl chloride used in an ordinary decorative film becomes hard and easy to tear particularly in a low temperature environment, and thus it is preferable not to use vinyl chloride in the resin layer of the present disclosure.

The resin layer of the present disclosure can include, as an optional component, for example, a filler, a reinforcing material, an antioxidant, a UV absorber, a light stabilizer, a thermal stabilizer, a dispersant, a plasticizer, a flow improving agent, a surfactant, a leveling agent, a silane coupling agent, a catalyst, a pigment, and a dye, within the range that does not inhibit the effects of the present disclosure.

As the adhesive layer of the present disclosure, from a perspective of wind, rain, and wind pressure resistance and the like, the adhesive layer includes a reaction product of a crosslinking agent and a (meth)acrylate polymer obtained from a material including a monoethylenically unsaturated monomer and an unsaturated monomer containing a carboxyl group, a glass transition temperature of the (meth)acrylate polymer is approximately −58° C. or more and approximately −40° C. or less, and the unsaturated monomer containing a carboxyl group is incorporated by an amount of approximately 3 mass % or more and approximately 10 mass % or less of a total amount of 100 mass % of the monoethylenically unsaturated monomer and the unsaturated monomer containing a carboxyl group.

The adhesive layer of the decorative film of the present disclosure has sufficient adhesiveness not only at ambient temperature but also at a low temperature, and thus, particularly, the decorative film of the present disclosure can provide an exterior that exhibits sufficient wind, rain, and wind pressure resistance even in the case of a vehicle traveling in a low temperature environment. While the adhesive layer of the present disclosure can be bonded firmly to an adherend without impairing adhesiveness, when the decorative film is to be released, the adhesive layer can be released without leaving glue on the adherend even after long term use (this performance may be referred to as “re-releasability”).

The adhesive layer of the present disclosure is formed from an adhesive, preferably a pressure-sensitive adhesive, including the reaction product of the (meth)acrylate polymer and the crosslinking agent. The (meth)acrylic polymer is a reaction product between a monoethylenically unsaturated monomer and an unsaturated monomer containing a carboxyl group. Such a (meth)acrylic polymer can be produced by solution polymerization or bulk polymerization by using a polymerization initiator such as benzoyl peroxide or azobisisobutyronitrile, or can be produced by emulsion polymerization by using a water-soluble initiator such as ammonium persulfate and potassium persulfate.

A glass transition temperature (Tg) of the (meth)acrylate polymer is approximately −40° C. or less, and may desirably be approximately −42° C. or less, approximately −44° C. or less, approximately −47° C. or less, approximately −52° C. or less, or approximately −54° C. or less. A lower limit value of the glass transition temperature is not particularly limited, but may be, for example, approximately −58° C. or more, approximately −56° C. or more, or approximately −57° C. or more. When the glass transition temperature of the (meth)acrylate polymer is within this range, a problem such as lifting up associated with wind, rain, and wind pressure can be reduced even while the decorative film has re-releasability performance. The glass transition temperature can be adjusted by arbitrarily selecting the type of monoethylenically unsaturated monomer and a blending amount of the monoethylenically unsaturated monomer.

Here, the glass transition temperature of the (meth)acrylic polymer can be determined by the following FOX equation with such a polymer being copolymerized from n types of monomers.

$$\frac{1}{T g + 273.15} = {\sum }_{i = 1}^{n} ( \frac{{X}_{i}}{{T}_{{g}_{i}} + 273.15} ) \qquad [ Equation 1 ]$$

In the equation, Tgᵢ indicates a glass transition temperature (° C.) of a homopolymer of a component i, Xᵢ indicates a mass fraction of a monomer of the component i added during polymerization, i is a natural number of 1 to n, and

$${\sum }_{i = 1}^{n} {X}_{i} = 1 \qquad [ Equation 2 ]$$

holds true.

Examples of the monoethylenically unsaturated monomer can include (meth)acrylate of the following chemical formula:

HRₐC═CHCOOR_{b}

[where, Rₐ is H, CH₃, or C₂H₅, and R_{b} is a linear or branched alkyl group having from 1 to 14 carbon atoms].

The monoethylenically unsaturated monomer may be used alone, or two or more types thereof may be used in combination.

From a perspective of adhesiveness and re-releasability, R_{b} is preferably a non-tertiary alkyl group having from 4 to 14 carbon atoms. A homopolymer of the (meth)acrylate preferably has a glass transition temperature (Tg) of approximately 0° C. or less.

Examples of the (meth)acrylate include butyl (meth)acrylate, 2-methyl butyl (meth)acrylate, 2-ethylhexyl (meth)acrylate, isooctyl (meth)acrylate, lauryl (meth)acrylate, n-decyl (meth)acrylate, 4-methyl-2-pentyl (meth)acrylate, isoamyl (meth)acrylate, s-butyl (meth)acrylate, and isononyl (meth)acrylate. Among these, from a perspective of adhesiveness, re-releasability and the like, butyl (meth)acrylate, 2-ethylhexyl (meth)acrylate, and isooctyl (meth)acrylate are preferable.

The monoethylenically unsaturated monomer may include a monomer other than the (meth)acrylate described above. Examples of such a monomer include ethyl (meth)acrylate, (meth)acrylamide, acrylonitrile, methacrylonitrile, α-olefin, vinyl ether, allyl ether, styrene, maleate, 2-hydroxyethyl (meth)acrylate, cyclohexyl (meth)acrylate, t-butyl (meth)acrylate, phenyl (meth)acrylate, isobornyl (meth)acrylate, 2-phenoxyethyl (meth)acrylate, N-vinylpyrrolidone, N-vinylcaprolactam, and substituted (meth)acrylamide such as (N-ethyl (meth)acrylamide, N-hydroxyethyl (meth)acrylamide, N-octyl (meth)acrylamide, N-t-butyl (meth)acrylamide, N,N-dimethyl (meth)acrylamide, N,N-diethyl (meth) acrylamide, and N-ethyl-N-dihydroxyethyl (meth)acrylamide. Among these, acrylonitrile and methacrylonitrile are preferable from a perspective of adhesiveness, re-releasability and the like, and acrylonitrile is more preferable.

The monoethylenically unsaturated monomer can be incorporated by an amount of approximately 90.0 mass % or more, approximately 91.0 mass % or more, or approximately 92.0 mass % or more, and can be incorporated by an amount of approximately 97.0 mass % or less, approximately 96.5 mass % or less, or approximately 97.0 mass %, of a total amount of 100 mass % of the monoethylenically unsaturated monomer and the unsaturated monomer containing a carboxyl group.

The unsaturated monomer containing a carboxyl group may be used alone or two or more types thereof may be used in combination. Examples of such an unsaturated monomer include (meth)acrylic acid, itaconic acid, maleic acid, and fumaric acid.

The unsaturated monomer containing a carboxyl group can be incorporated by an amount of approximately 3.0 mass % or more, approximately 3.5 mass % or more, or approximately 4.0 mass % or more, and can be incorporated by an amount of approximately 10.0 mass % or less, approximately 9.0 mass % or less, or approximately 8.0 mass % or less, of a total amount of 100 mass % of the monoethylenically unsaturated monomer and the unsaturated monomer containing a carboxyl group. When the content of the unsaturated monomer containing a carboxyl group is within this range, a problem such as lifting up associated with wind, rain, and wind pressure can be reduced even while the decorative film has re-releasability performance.

The adhesive layer of the present disclosure can be formed from a crosslinking-type adhesive composition, particularly a pressure-sensitive adhesive composition, including a reaction product of a (meth)acrylic polymer and a crosslinking agent.

As the crosslinking agent, for example, at least one selected from a bisamide compound and an epoxy compound can be used.

Examples of the bisamide compound can include a bis aziridine derivative of dibasic acid, and can preferably include an aromatic bisamide represented by the following chemical formula:

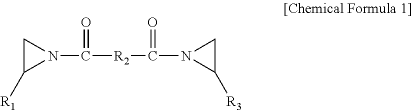

[where, R₁ and R₃ are independently selected from the group consisting of H and CₙH₂ₙ₊₁ (where n is an integer in the range of from 1 to 5), and R₂ is a divalent group selected from the group consisting of benzene (—C₆H₄—), substituted benzene, triazine, CₘH₂ₘ (where m is an integer in the range of from 1 to 10), and combinations thereof].

A particularly useful bisamide compound that falls within the above chemical formula is 1,1′-isophthaloyl-bis (2-methylaziridine) as described in U.S. Pat. No. 4,418,120 (Kealy et al.).

As the epoxy compound, an aliphatic cyclic polyepoxide, an aliphatic polyepoxide, an aromatic polyepoxide, and the like can be used.

As the aliphatic cyclic polyepoxide, for example, vinylcyclohexene dioxide, 3,4-epoxycyclohexylmethyl-3,4-epoxycyclohexane carboxylate, and 2,2-bis (3,4-epoxycyclohexyl) propane can be used.

As the aliphatic polyepoxide, for example, 1,4-bis (2,3-epoxypropoxy) butane, as well as a polyglycidyl ether of aliphatic polyol such as glycerol, polypropylene glycol, and 1,4-butanediol, and a diglycidyl ester of linoleic dimer acid can be used.

As the aromatic polyepoxide, for example, a bisphenol A type resin and a derivative thereof, a bisphenol F resin and a derivative thereof, and other such polyglycidyl ethers of polyhydric phenols, and a glycidyl ester of aromatic carboxylic acid, and mixtures thereof can be used. A polyglycidyl amine compound such as N,N-diglycidyl aniline, N,N-diglycidyl toluidine, and p-N,N-diglycidyl aminophenyl glycidyl ether, and mixtures thereof can also be used.

The crosslinking agent can be set to approximately 0.08 equivalents or more or approximately 0.15 equivalents or more, and can be set to approximately 0.62 equivalents or less or approximately 0.50 equivalents or less relative to 1 equivalent of carboxyl groups in the (meth)acrylic polymer.

The adhesive layer of the present disclosure can include, as an optional component, for example, a filler, a reinforcing material, an antioxidant, a UV absorber, a light stabilizer, a thermal stabilizer, a tackifier, a dispersant, a plasticizer, a flow improving agent, a surfactant, a leveling agent, a silane coupling agent, a catalyst, a pigment, and a dye, within the range that does not inhibit the effects of the present disclosure.

The thickness of the adhesive layer of the present disclosure is not limited to the following, but can be set to, for example, approximately 5 μm or more, approximately 10 μm or more, or approximately 20 μm or more, and can be set to approximately 200 μm or less, approximately 100 μm or less, or approximately 80 μm or less.

The decorative film of the present disclosure is not limited to the following, but depending on a usage environment, a decorative property and the like, can further include at least one selected from the group consisting of, for example, a decorative layer, a protective layer, a brightening layer, a bonding layer, and a release liner.

Examples of the decorative layer of the decorative film of the present disclosure include, but are not limited to: a color layer that exhibits a paint color, for example a light color such as white and yellow, or a dark color such as red, brown, green, blue, gray, and black; a pattern layer that imparts to an article a pattern, a logo, a design or the like such as a wood grain tone, a stone grain tone, a geometric pattern, and a leather pattern; a relief (embossed carving pattern) layer provided with an uneven shape on a surface; and combinations thereof.

While not limited to the following, the decorative layer can be applied directly or through the bonding layer or the like to an entire surface or a portion of a layer constituting the decorative film, for example, the protective layer, the resin layer, or the adhesive layer.

As a material of the color layer, for example, a material in which a pigment such as an inorganic pigment such as carbon black, yellow lead, yellow iron oxide, Bengala, or red iron oxide; a phthalocyanine pigment such as phthalocyanine blue or phthalocyanine green; and an organic pigment such as an azo lake pigment, an indigo pigment, a perinone pigment, a perylene pigment, a quinophthalone pigment, a dioxazine pigment, and a quinacridone pigment such as quinacridone red is dispersed in a binder resin such as a (meth)acrylic resin or a polyurethane resin can be used. However, the material of the color layer is not limited thereto. Among these, a polyurethane resin is preferable from a perspective of impact resistance.

Such a material can be used to form the color layer by a coating method such as gravure coating, roll coating, die coating, bar coating, and knife coating, for example.

As the pattern layer, a pattern layer obtained by, for example, directly applying a pattern, a logo, a design, or other such patterns to the protective layer, the resin layer, the adhesive layer, or the like by using a printing method such as gravure direct printing, gravure offset printing, inkjet printing, laser printing, or screen printing can be adopted, or a film, a sheet, or the like having a pattern, a logo, a design, or the like formed by coating such as gravure coating, roll coating, die coating, bar coating, and knife coating, or by punching, etching, or the like can also be used. However, the pattern layer is not limited thereto. For example, a material similar to the material used in the color layer can be used as the material of the pattern layer.

As the relief layer, a thermoplastic resin film having a concavo-convex shape on a surface obtained by a conventionally known method such as embossing, scratching, laser machining, dry etching, or hot pressing can be used. The relief layer can also be formed by coating the release liner having a concavo-convex shape with a thermosetting or radiation curable resin such as a curable (meth)acrylic resin, curing by heating or radiation irradiation, and removing the release liner.

The thermoplastic resin, the thermosetting resin, and the radiation curable resin used in the relief layer are not particularly limited, and for example, a fluororesin, PET, PEN, and other such polyester resins, a (meth)acrylic resin, polyethylene, polypropylene, and other such polyolefin resins, a thermoplastic elastomer, a polycarbonate, a polyamide, an ABS resin, an acrylonitrile-styrene resin, polystyrene, vinyl chloride, and polyurethane can be used. Among these, polyurethane is preferable from a perspective such as impact resistance. The relief layer may include at least one of the pigments used in the color layer.

The decorative layer of the present disclosure can include, as an optional component, for example, a filler, a reinforcing material, an antioxidant, a UV absorber, a light stabilizer, a thermal stabilizer, a dispersant, a plasticizer, a flow improving agent, a surfactant, a leveling agent, a silane coupling agent, and a catalyst within the range that does not inhibit the effects of the present disclosure, a decorative property, and the like.

The thickness of the decorative layer is not particularly limited and may be adjusted arbitrarily according to the required decorative property and the required concealment property. For example, the thickness of the decorative layer can be set to approximately 1.0 μm or more, approximately 3.0 μm or more, or approximately 5.0 μm or more, and can be set to approximately 50 μm or less, approximately 40 μm or less, or approximately 30 μm or less.

To impart performance such as weather resistance and solvent resistance, for example, the protective layer can be applied to an outermost surface of the decorative film of the present disclosure. The protective layer is preferably transparent or translucent such that the decorative layer positioned at a lower layer can be recognized visually.

A material of the protective layer that can be applied to the decorative film of the present disclosure is not limited to the following, but as the material of the protective layer, for example, a (meth)acrylic resin including polymethyl methacrylate (PMMA) and a (meth)acrylate copolymer, polyurethane, an ethylene-tetrafluoroethylene copolymer (ETFE), a fluororesin such as polyvinylidene fluoride (PVDF) and a methyl methacrylate-vinylidene fluoride copolymer (PMMA/PVDF), a silicone resin, polyvinyl chloride (PVC), polycarbonate (PC), polyethylene (PE), polypropylene (PP), or other such polyolefin, a polyester such as polyethylene terephthalate (PET) and polyethylene naphthalate (PEN), and a copolymer such as an ethylene-acrylic acid copolymer (EAA) and an ionomer thereof, an ethylene-ethyl acrylate copolymer, and an ethylene-vinyl acetate copolymer can be used alone or as a blend of two or more types thereof.

Among these, from a perspective of chemical resistance (solvent resistance) and/or weather resistance, the use of a (meth)acrylic resin, a polyurethane resin, a fluororesin, and polyvinyl chloride is preferable, and from a perspective of scratch resistance, and/or an environmental load in incineration and burying as waste, the use of a (meth)acrylic resin and a polyurethane resin is more preferable, and a polyurethane resin is most preferable.

The polyurethane resin can be obtained, for example, from a polyurethane resin composition including a polyisocyanate and a polyol.

As the polyisocyanate, for example, a polyisocyanate that contains approximately 0.5 equivalents or more of an isocyanurate body or adduct body of isophorone diisocyanate or both relative to the total polyisocyanate can be used. Such a polyisocyanate can improve a breaking elongation rate, and particularly breaking elongation rate at a high temperature.

The isocyanurate body of isophorone diisocyanate is available, for example, from Sumitomo Bayer Urethane Co., Ltd. under the trade name “Desmodur (trade name) Z4370” or from Daicel Hulz Co., Ltd. under the trade name “IPDI.” The adduct body of isophorone diisocyanate is an adduct of isophorone diisocyanate and trimethylolpropane, trimethylolethane, pentaerythritol, or the like, and the adduct with trimethylolpropane is available, for example, from Takeda Pharmaceutical Co., Ltd. under “Takenate (trade name) D-140N.”

As the polyol, for example, a polyol containing, relative to the total polyol, approximately 0.4 equivalents or more of a polyester polyol having a weight average molecular weight of approximately 1000 or less can be used. Such a polyol can improve a breaking elongation rate, and particularly a breaking elongation rate at a high temperature. Here, the “weight average molecular weight” refers to a weight average molecular weight in terms of polystyrene as measured by gel permeation chromatography (GPC).

Examples of preferred polyester polyol include caprolactone diol and polycarbonate diol. One type of these polyester polyols may be used alone, or two or more types thereof may be used in combination.

Specific examples of the polyester polyol can include a caprolactone diol such as “TONE 0201” (available from Union Carbide Corporation; weight average molecular weight of 530), “Placcel (trade name) 205” (available from Daicel Chemical Industries, Ltd.; weight average molecular weight of 530), “Placcel (trade name) 205H” (available from Daicel Chemical Industries, Ltd.; weight average molecular weight of 530), “Placcel (trade name) 208” (available from Daicel Chemical Industries, Ltd.; weight average molecular weight of 850), and “Placcel (trade name) 210” (available from Daicel Chemical Industries, Ltd.; weight average molecular weight of 1000).

Optionally, in place of these caprolactone diols, or in combination with these compounds, a caprolactone triol such as “TONE 0301” (available from Union Carbide Corporation; weight average molecular weight of 300), “TONE 1303” (available from Union Carbide Corporation; weight average molecular weight 425), “TONE 0305” (available from Union Carbide Corporation; weight average molecular weight of 540), “Placcel (trade name) 305” (available from Daicel Chemical Industries, Ltd.; weight average molecular weight of 550), and “Placcel (trade name) 308” (available from Daicel Chemical Industries, Ltd.; weight average molecular weight of 850) may be used.

Specific examples of the polycarbonate diol can include, for example, “Nippolan (trade name) 981” and “Nippolan (trade name) 983” (available from Nippon Polyurethane Industry Co., Ltd.; weight average molecular weight of 1000), and “T4671”, “T4691”, and “T5651” (all available from Asahi Kasei Corporation; weight average molecular weight of 1000).

When a caprolactone diol and a polycarbonate diol are used in combination, these diols can be used in the polyester polyol at various amount ratios. For example, both can be used at an equivalent ratio of approximately 1:approximately 9 to approximately 9:approximately 1. Here, when these diols are mixed at such ratios, a weight average molecular weight in that state may be approximately 1000 or less, approximately 850 or less, or approximately 750 or less, and is preferably in the range of from approximately 500 to approximately 600.

When a caprolactone diol is used alone, the weight average molecular weight of the caprolactone diol may be approximately 700 or less, and is preferably in the range of from approximately 500 to approximately 600.

An equivalent ratio of the polyisocyanate and the polyol in the polyurethane resin composition is not particularly limited, and may be adjusted arbitrarily to obtain desired protection performance. For example, the equivalent ratio of the polyisocyanate to the polyol can be set in the range of polyisocyanate/polyol=approximately 0.7 to approximately 2.0. When the equivalent ratio of the polyisocyanate and the polyol is within this range, a breaking elongation rate, particularly, a breaking elongation rate at a high temperature can be improved.

The polyurethane resin composition including a polyisocyanate and a polyol can be used to prepare the polyurethane resin by using a known technique arbitrarily. For example, polymerization can be carried out in a state in which a catalyst is blended in the polyurethane resin composition. A usual catalyst can be used as such a catalyst, and for example, a dibutyltin dilaurate (DBTDL) catalyst, zinc naphthenate, zinc octenate, and triethylenediamine can be used. An amount of the catalyst can be set from approximately 0.005 mass % to approximately 0.5 mass % relative to 100 wt. % of the resin composition. Polymerization for forming the polyurethane resin can typically be carried out at a temperature of from approximately 60° C. to approximately 160° C.

The protective layer may be of a single layer structure or may be of a multilayer structure. In the case of the multilayer structure, for example, the protective layer may be a laminate of a film formed from the resin described above, or may be a multilayer coating of the resin described above. The protective layer may have a three-dimensional concavo-convex shape such as an embossed pattern on an entire surface or a portion of the protective layer.

The protective layer can be formed by applying the resin composition onto or above the decorative layer directly or through the bonding layer or the like by using a known coating method such as knife coating and bar coating. The coating of the protective layer can be carried out before or after the decorative film is applied to an adherend. Alternatively, the release liner can be coated with the resin composition to form a protective layer film, and the film can be laminated on the decorative layer through the bonding layer. When the decorative layer has adhesiveness with respect to the protective layer film formed on the release liner, the protective layer film can also be laminated directly onto the decorative layer without interposing the bonding layer between the protective layer film and the decorative layer. The protective layer film can be formed, for example, by coating the release liner or the like with a resin material such as a curable (meth)acrylic resin composition and a reactive polyurethane composition by knife coating, bar coating, blade coating, doctor coating, roll coating, or cast coating, and performing light or heat curing as necessary.

A protective layer formed into a film shape in advance by extrusion or stretching may be used as the protective layer. Such a film can be laminated onto the decorative layer through the bonding layer. Alternatively, when the decorative layer has adhesiveness with respect to such a film, the film can be laminated directly onto the decorative layer without interposing the bonding layer. When a film having a high level of flatness is used as such a film, an appearance with higher surface flatness can be imparted to a structure (vehicle).

The protective layer of the present disclosure can include, as an optional component, for example, a filler, an antioxidant, a UV absorber, a light stabilizer, a thermal stabilizer, a hard coat material, a glossiness imparting agent, a dispersant, a plasticizer, a flow improving agent, a surfactant, a leveling agent, a silane coupling agent, a catalyst, a pigment, and a dye, within the range that does not inhibit the effects of the present disclosure and protection performance or the like according to application. Among these, a UV absorber such as benzotriazole or Tinuvin (trade name) 400 (available from BASF SE), a hindered amine light stabilizer (HALS) such as Tinuvin (trade name) 292 (available from BASF SE) and the like can be used to effectively prevent discoloration, fading, and deterioration of a colorant material (in particular, an organic dye or pigment having relatively high sensitivity to light such as ultraviolet light) incorporated in the decorative layer positioned at a lower layer. The hard coat material may be incorporated in the protective layer, or the protective layer may be coated separately with the hard coat material and the hard coat material may be applied as a hard coat layer.

The thickness of the protective layer is not particularly limited and may be adjusted arbitrarily according to the required protection performance. For example, the thickness of the protective layer can be set to approximately 1.0 μm or more, approximately 3.0 μm or more, or approximately 5.0 μm or more, and can be set to approximately 50 μm or less, approximately 40 μm or less, or approximately 30 μm or less.

The brightening layer is not limited to the following, but may be a layer that includes a metal selected from aluminum, nickel, gold, silver, copper, platinum, chromium, iron, tin, indium, titanium, lead, zinc, and germanium, or an alloy or a compound thereof, and that is formed by vacuum deposition, sputtering, ion plating, plating, or the like on an entire surface or a portion of a layer constituting the decorative film, for example, the decorative layer of the protective layer including the decorative layer, or the resin layer. The thickness of the brightening layer can be selected arbitrarily according to the required decorative property, brightness and the like.

A bonding layer (may be referred to as a “primer layer” or the like) may be used to join the layers constituting the decorative film. As the bonding layer, for example, a commonly used (meth)acrylic-based, polyolefin-based, polyurethane-based, polyester-based, or rubber-based solvent type, emulsion type, pressure sensitive type, heat sensitive type, thermosetting type, or UV curing type adhesive can be used. The bonding layer can be applied by a known coating method or the like.

The bonding layer of the present disclosure can include, as an optional component, for example, a filler, a reinforcing material, an antioxidant, a UV absorber, a light stabilizer, a thermal stabilizer, a tackifier, a dispersant, a plasticizer, a flow improving agent, a surfactant, a leveling agent, a silane coupling agent, a catalyst, a pigment, and a dye, within the range that does not inhibit the effects of the present disclosure, a decorative property, and the like.

The thickness of the bonding layer can be set, for example, to approximately 0.05 μm or more, approximately 0.5 μm or more, or approximately 5 μm or more, and can be set to approximately 100 μm or less, approximately 50 μm or less, or approximately 20 μm or less.

Any suitable release liner can be used to protect the adhesive layer. Examples of a typical release liner include those prepared from paper (e.g., kraft paper), and from polymeric materials (e.g., polyolefin such as polyethylene or polypropylene, ethylene vinyl acetate, polyurethane, polyethylene terephthalate, and other such polyester). On the release liner, a layer of a release agent such as a silicone-containing material or a fluorocarbon-containing material may be applied as necessary.

The thickness of the release liner can be set, for example, to approximately 5 μm or more, approximately 15 μm or more, or approximately 25 μm or more, and can be set to approximately 300 μm or less, approximately 200 μm or less, or approximately 150 μm or less.

The decorative film of the present disclosure can be used for an exterior of a vehicle. The vehicle is not particularly limited, and examples of the vehicle can include a vehicle such as an automobile and a railway vehicle (including a linear motor car), a ship, and an aircraft. Among these, the decorative film of the present disclosure is preferably used as an exterior of a high-speed vehicle (for example, a high-speed railway vehicle such as a bullet train and a linear motor car) or an aircraft that travels at high speed, and in particular, travels at high speed in a low temperature environment. In particular, since the decorative film including the polyurethane resin layer has excellent impact resistance (chipping resistance), the decorative film is preferably used as an exterior for a high-speed vehicle (for example, a high-speed railway vehicle such as a bullet train and a linear motor car) that is susceptible to sand or small stones during travel.

The decorative film of the present disclosure can be attached to an adherend (outer peripheral member of a vehicle) through the adhesive layer of the decorative film by using, for example, a spatula or the like as necessary. A material of the adherend is not particularly limited, and examples of the material can include a metal such as iron, aluminum, and stainless steel, or metal alloys thereof, and a resin material that may include reinforced fiber, and the like. A surface of the adherend may be subjected to a surface treatment, painting, or the like.

The decorative film of the present disclosure can be manufactured, for example, by using a coating method or the like to form the decorative layer, the adhesive layer, or the like on the release liner such as a PET film of which a surface has been release treated, or on, for example, the resin layer constituting the decorative film, and then laminating these layers through the bonding layer as necessary. Alternatively, a coating step and, as necessary, a drying and/or curing step can be repeated to sequentially laminate each layer on one release liner. The decorative film can also be formed by multilayer extrusion of the material of each layer.

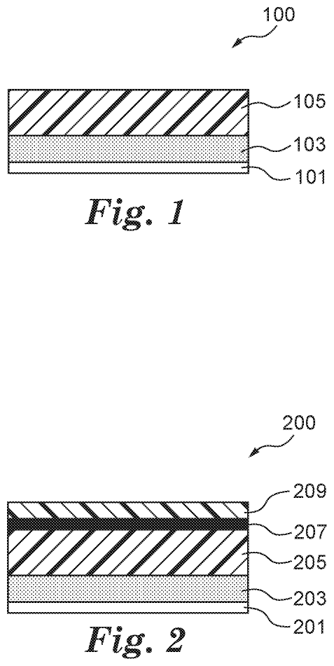

An example of a method for manufacturing the decorative film of the present disclosure will be described illustratively with reference to FIG. 1 and FIG. 2, but the method for manufacturing the decorative film is not limited thereto.

The decorative film of a configuration of FIG. 1 is, for example, formed by applying an adhesive layer 103 onto a release liner 101 by using a knife coater or the like, and then further applying a drying and/or curing step as necessary to form a laminate A. A decorative film 100 can be formed by applying the adhesive layer of such a laminate A to a resin layer 105.

The decorative film of a configuration of FIG. 2 is, for example, formed by applying a decorative layer 207 onto a resin layer 205 by using a gravure ink, a gravure coating method and the like, and further applying a drying and/or curing step as necessary, and then applying a protective layer 209 onto the decorative layer 207 by using a knife coater or the like, and further applying a drying and/or curing step as necessary to form a laminate B. A decorative film 200 can be formed by producing the laminate A in the same manner as described above, and applying the adhesive layer 203 to the resin layer 205 of the laminate B.

### EXAMPLES

Specific embodiments of the present disclosure will be exemplified in the following examples, but the present invention is not limited to these embodiments. All parts and percentages are based on mass, unless otherwise stated.

Products and the like used in the examples are shown in Table 1 below.

TABLE 1

| Compound name, product name or | | |
|---|---|---|
| abbreviation | Description | Provider |
| BA | Butyl acrylate | Nippon Shokubai Co., Ltd. |
| | | (Osaka-shi, Osaka, Japan) |
| 2EHA | 2-ethylhexyl acrylate | Nippon Shokubai Co., Ltd. |
| | | (Osaka-shi, Osaka, Japan) |
| AN | Acrylonitrile | Mitsubishi Chemical Corporation |
| | | (Chiyoda-ku, Tokyo, Japan) |
| IOA | Isooctyl acrylate | 3M Japan Ltd. (Shinagawa-ku, |
| | | Tokyo, Japan) |
| AA | Acrylic acid | Fujifilm Wako Pure Chemical |
| | | Corporation (Osaka-shi, Osaka, |
| | | Japan) |
| V65 | 2,2′-azobis (2,4- | Tosoh Corporation (Minato-ku, |
| | dimethylvaleronitrile) | Tokyo, Japan) |
| | (polymerization initiator) | |
| Crosslinking agent | Bisamide-based crosslinking agent | 3M Japan Ltd. (Shinagawa-ku, |
| | | Tokyo, Japan) |
| Nippolan (trade name) 983 | Polycarbonate diol | Tosoh Corporation (Minato-ku, |
| | | Tokyo, Japan) |
| Placcel (trade name) 205H | Polycaprolactone diol | Daicel Corporation (Minato-ku, |
| | | Tokyo, Japan) |
| Tinuvin (trade name) 292 | Light stabilizer | BASF Japan Ltd. (Minato-ku, |
| | | Tokyo, Japan) |
| DBTDL | Dibutyltin dilaurate | Tokyo Chemical Industry Co., Ltd. |
| | (polymerization catalyst) | (Chuo-ku, Tokyo, Japan) |
| VESTANAT (trade name) T | Isocyanmate body of isophorone | Daicel-Evonik Ltd. (Shinjuku-ku, |
| 1890E | diisocyanate | Tokyo, Japan) |
| TX-6013A | Urethane-based paint | BASF Japan Ltd. (Minato-ku, |
| | | Tokyo, Japan) |
| Urethane film | Film made of polyurethane resin | Sheedom Co., Ltd. (Chuo-ku, |
| | | Osaka-shi, Japan) |
| PET film | Film of polyethylene terephthalate | Toyobo Co., Ltd. (Osaka-shi, |
| | resin | Osaka, Japan) |
| 3M (trade name) Scotchcal (trade | Film including polyvinyl chloride | 3M Japan Ltd. (Shinagawa-ku, |
| name) film | and adhesive layer | Tokyo, Japan) |
| Release Liner 1 | PET release liner | Toray Co., Ltd. (Chuo-ku, Tokyo, |
| | | Japan) |
| Release Liner 2 | Release liner including | 3M Japan Ltd. (Shinagawa-ku, |
| | polyethylene layer and paper layer | Tokyo, Japan) |

The materials shown in Table 1 were mixed at blending ratios shown in Table 2, and various coating solutions for producing the protective layer, the decorative layer, and the adhesive layer (pressure-sensitive adhesive layer) were produced. Here, with regard to the coating solution for the adhesive layer, each of monomers was mixed at the ratio shown in Table 2, and 0.2 parts by mass of V65 that is a polymerization initiator was further added, and heated for 24 hours at 50° C. to prepare an acrylate polymer that was used as the coating solution. The units of the numerical values in Table 2 are all parts by mass.

TABLE 2

| | | | | | | Protective layer | Decorative layer |
|---|---|---|---|---|---|---|---|
| | Adhesive layer coating solution | | | | | coating solution | coating solution |
| | Ad-1 | Ad-2 | Ad-3 | Ad-4 | Ad-5 | P-1 | C-1 |
| BA | 58 | — | 94 | 90 | 98 | — | — |
| 2EHA | 36 | — | — | — | — | — | — |
| AN | 1 | — | — | — | — | — | — |
| IOA | — | 90 | — | — | — | — | — |
| AA | 5 | 10 | 6 | 10 | 2 | — | — |
| Nippolan (trade name) 983 | — | — | — | — | — | 50 | — |
| Placcel (trade name) 205H | — | — | — | — | — | 50 | — |
| Tinuvin (trade name) 292 | — | — | — | — | — | 2.5 | — |
| DBTDL | — | — | — | — | — | 0.05 | — |
| VESTANAT (trade name) T | — | — | — | — | — | 85 | 4 |
| 1890E | | | | | | | |
| TX-6013A | — | — | — | — | — | — | 100 |

### Example 1

An approximately 150 μm-thick urethane film that is a resin layer was coated with a decorative layer coating solution C-1 by using a knife coater, and subsequently dried by heating for 10 minutes at 80° C. to form a laminate A including a decorative layer having a thickness of approximately 25 μm. Then, the decorative layer of the urethane film was coated with a protective layer coating solution P-1 by using a knife coater, and subsequently dried by heating for 3 minutes at 80° C. to form a protective layer having a thickness of approximately 25 μm, and a release liner 1 was applied onto such a protective layer and held at room temperature for three days to form a laminate B.

A release liner 2 was coated with an adhesive layer coating solution Ad-1 by using a knife coater, and subsequently dried by heating for 5 minutes at 95° C. to form a laminate C including an adhesive layer having a thickness of approximately 30 μm. The adhesive layer of the laminate C was affixed to a surface of the urethane film of the laminate B to form a decorative film.

### Example 2

A laminate C was prepared in the same manner as in Example 1, and an adhesive layer of such a laminate C was affixed to a surface of a urethane film having a thickness of approximately 150 μm to form a decorative film of Example 2.

### Example 3

A decorative film of Example 3 was formed in the same manner as in Example 2 with the exception that a urethane film having a thickness of approximately 100 μm was used.

### Example 4

A decorative film of Example 4 was formed in the same manner as in Example 2 with the exception that a PET film having a thickness of approximately 188 μm was used.

### Example 5

A decorative film of Example 5 was formed in the same manner as in Example 2 with the exception that the adhesive layer coating solution was changed from Ad-1 to Ad-3.

### Example 6

A decorative film of Example 6 was formed in the same manner as in Example 2 with the exception that the adhesive layer coating solution was changed from Ad-1 to Ad-4.

### Comparative Example 1

A decorative film of Comparative Example 1 was formed in the same manner as in Example 2 with the exception that a urethane film having a thickness of approximately 50 μm was used.

### Comparative Example 2

A decorative film of Comparative Example 2 was formed in the same manner as in Example 2 with the exception that the adhesive layer coating solution was changed from Ad-1 to Ad-2.

### Comparative Example 3

A decorative film of Comparative Example 3 was formed in the same manner as in Example 2 with the exception that the adhesive layer coating solution was changed from Ad-1 to Ad-2, and a urethane film having a thickness of approximately 50 μm was used.

### Comparative Example 4

A 3M (trade name) Scotchcal (trade name) film was used as a decorative film of Comparative Example 4. Here, such a film includes a vinyl chloride (PVC) film having a thickness of approximately 55 μm, and an adhesive layer having a thickness of approximately 30 μm, and the adhesive layer was prepared by using the adhesive layer coating solution Ad-1.

### Comparative Example 5

A decorative film of Comparative Example 5 was formed in the same manner as in Example 2 with the exception that the adhesive layer coating solution was changed from Ad-1 to Ad-5.

### Physical Property Evaluation Test

Properties of the resin layer and the decorative film were evaluated by using the following method.

### Tearing Strength Test

Tearing strength of the urethane film, the PET film, and the vinyl chloride film that are the resin layers were measured in three temperature atmospheres of 20° C., 5° C., and −5° C. in accordance with JIS K-7128-3. The results are shown in Table 3.

### Adhesive Strength Test

When present, the release liner 1 was removed, and the decorative film was laminated with a coated film (PVC overlaminate film available from 3M, product number: 114116N), and subsequently the film was cut into a size of approximately 1 inch×approximately 6 inches, and the decorative film was affixed through the adhesive layer to a painted aluminum plate measuring approximately 1 inch×approximately 3 inches to prepare a test piece. The obtained test piece was left to stand for approximately 24 hours in an environment of approximately 20° C. and approximately 65% RH, or in an environment of approximately 5° C., and subsequently the test piece was attached to a tensile tester (RTC-1210A, available from Orientec Co., Ltd.), and the test piece was pulled at an angle of 180 degrees with respect to the aluminum plate at speed of approximately 300 mm/min, and adhesive strength was measured. The results are shown in Table 3.

### High Pressure Washing Test: Wind, Rain, and Wind Pressure Resistance

When present, the release liner 1 was removed, and subsequently the decorative film was cut into a size of approximately 15 mm×approximately 100 mm, and the decorative film was affixed through the adhesive layer to a painted aluminum plate to prepare a test piece. Such a test piece was fixed to a metal plate, and a high-pressure washer (HDS 8/15C available from Alfred Karcher GmbH & Co.) was used to discharge water for 60 seconds onto an edge of the test piece on which the decorative film was affixed. Water discharge conditions of the high-pressure washer are as described below. When there was no deformation of the decorative film, and no lifting up and peeling were observed on the test piece, the test piece was evaluated as being “excellent.” When there was no deformation of the decorative film, but a slight amount of either lifting up or peeling was observed, the test piece was evaluated as being “acceptable.” When deformation of the decorative film, and either lifting up or peeling were clearly observed, the test piece was evaluated as being “unacceptable.” The results are shown in Table 3.

Water Discharge Conditions

Hydraulic pressure: approximately 8.0±approximately 2 MPa

Water discharge amount: approximately 7±approximately 1 L/min

Water discharge angle with respect to test piece: approximately 20 degrees

Distance between nozzle and test piece: approximately 100 mm

Water temperature: from approximately 5° C. to approximately 15° C.

### Impact Resistance Test

When present, the release liner 1 was removed, and subsequently the decorative film was cut into a size of approximately 70 mm×approximately 70 mm, and the decorative film was affixed through the adhesive layer to an aluminum plate to prepare a test piece. The test piece was subjected to an impact resistance test by using a gravel tester (JA-400) available from Suga Test Instruments Co., Ltd. in an environment of approximately −5° C. under the following conditions.

Gravel: No. 6 gravel (basalt)

Gravel weight: 500 g

Air pressure: 4 kg/cm²

After the test ended, the decorative film was peeled from the test piece. When the decorative film was able to be released without tearing, the decorative film was evaluated as being “excellent.” When a portion of the decorative film was torn, but the decorative film was able to be released, the decorative film was evaluated as being “acceptable.” When the decorative film tore and could not be released, the decorative film was evaluated as being “unacceptable.” The results are shown in Table 3.

TABLE 3

| | | | Example 1 | Example 2 | Example 3 | Example 4 | Example 5 | Example 6 |
|---|---|---|---|---|---|---|---|---|
| Resin layer material | | | Urethane | Urethane | Urethane | PET | Urethane | Urethane |
| Thickness of resin layer (μm) | | | 150 | 150 | 100 | 188 | 150 | 150 |
| Tg of adhesive layer (° C.) | | | −55 | −55 | −55 | −55 | −49 | −45 |
| Acrylic acid content in | | | 5.0 | 5.0 | 5.0 | 5.0 | 6.0 | 10.0 |
| adhesive layer (mass %) | | | | | | | | |
| Physical | Tearing | 20° C. | 16.7 | 16.7 | 11.5 | 86.2 | 16.7 | 16.7 |
| Property | strength (N) | 5° C. | 26.5 | 26.5 | 20 | 85.7 | 26.5 | 26.5 |
| Evaluation | | −5° C. | 30.7 | 30.7 | 23.2 | 62.2 | 30.7 | 30.7 |
| | Adhesive | 20° C., | 14.0 | 14.0 | 14.0 | 14.0 | 12.0 | 19.0 |
| | strength after | 65% RH | | | | | | |
| | 24 hours (N) | 5° C. | 30.0 | 30.0 | 30.0 | 30.0 | 17.0 | 21.0 |

| | | | | | | |
|---|---|---|---|---|---|---|
| High Pressure Washing | Excellent | Excellent | Acceptable^{b)} | Excellent | Excellent | Excellent |
| Test | | | | | | |
| Impact Resistance Test | Excellent | Excellent | Excellent | Excellent | Excellent | Excellent |

| | | | Comparative | Comparative | Comparative | Comparative | Comparative |
|---|---|---|---|---|---|---|---|
| | | | Example 1 | Example 2 | Example 3 | Example 4 | Example 5 |
| Resin layer material | | | Urethane | Urethane | Urethane | PVC | Urethane |
| Thickness of resin layer (μm) | | | 50 | 150 | 50 | 55 | 150 |
| Tg of adhesive layer (° C.) | | | −55 | −60 | −60 | −55 | −53 |
| Acrylic acid content in | | | 5.0 | 10.0 | 10.0 | 5.0 | 2.0 |
| adhesive layer (mass %) | | | | | | | |
| Physical | Tearing | 20° C. | 6.2 | 16.7 | 6.2 | 5.4 | 16.7 |
| Property | strength (N) | 5° C. | 11.1 | 26.5 | 11.1 | 1.2 | 26.5 |
| Evaluation | | −5° C. | 13.5 | 30.7 | 13.5 | 0.9 | 30.7 |
| | Adhesive | 20° C., | 14.0 | 22.0 | 22.0 | 14.0 | 13.0 |
| | strength after | 65% RH | | | | | |
| | 24 hours (N) | 5° C. | 30.0 | Un- | Un- | 30.0 | 15.0 |
| | | | | measurable^{a)} | measurable^{a)} | | |

| | | | | | |
|---|---|---|---|---|---|
| High Pressure Washing | Un- | Un- | Un- | Un- | Un- |
| Test | acceptable^{c)} | acceptable^{d)} | acceptable^{c)} | acceptable^{e)} | acceptable^{c)} |
| Impact Resistance Test | Excellent | Excellent | Excellent | Unacceptable | Excellent |

^{a)}Could not be measured because a sound was made from the glass substrate and the decorative film peeled all at once.
^{b)}There were traces of lifting up at a portion of the film, but there was no film deformation.
^{c)}Film deformation was present. Lifting up was present over the entire film.
^{d)}Film deformation was present. Lifting up was present at a portion of the film.
^{e)}The film was torn.

It will be apparent to those skilled in the art that various modifications can be made to the embodiments and the examples described above without departing from the principles of the present invention. In addition, it will be apparent to those skilled in the art that various improvements and modifications of the present invention can be carried out without departing from the gist and the scope of the present invention.

### REFERENCE SIGNS LIST

100, 200: Decorative film for vehicle exterior
101, 201: Release liner
103, 203: Adhesive layer
105, 205: Resin layer
207: Decorative layer
209: Protective layer

1. A decorative film for a vehicle exterior, the film comprising a resin layer and an adhesive layer; wherein
tearing strength of the resin layer is 8.0 N or more at 20° C.;
the adhesive layer includes a reaction product of a crosslinking agent and a (meth)acrylate polymer obtained from a material including a monoethylenically unsaturated monomer and an unsaturated monomer containing a carboxyl group; and
a glass transition temperature of the (meth)acrylate polymer is −58° C. or more and −40° C. or less, and the unsaturated monomer containing a carboxyl group is incorporated by an amount of 3 mass % or more and 10 mass % or less of a total amount of 100 mass % of the monoethylenically unsaturated monomer and the unsaturated monomer containing a carboxyl group.

2. The decorative film according to claim 1, wherein the tearing strength of the resin layer is 15.0 N or more at −5° C.

3. The decorative film according to claim 1, wherein a thickness of the resin layer is 100 μm or more.

4. The decorative film according to claim 1, wherein the resin layer includes at least one selected from a polyurethane resin, a polyolefin resin, and a polyester resin.

5. The decorative film according to claim 1, further comprising at least one selected from a protective layer and a decorative layer.

6. The decorative film according to claim 1, wherein the decorative film is used for an exterior of a railway vehicle.
